(19) United States
(12) Patent Application Publication
(10) Pub. No.: US 2026/0303986 A1
(43) Pub. Date: Oct. 1, 2026

(54) TIME-AWARE AUTO WHITE BALANCE IN MOBILE PHOTOGRAPHY

(71) Applicant: SAMSUNG ELECTRONICS CO., LTD., Suwon-si (KR)

(72) Inventors: Mahmoud Afifi, Toronto (CA); Luxi Zhao, Toronto (CA); Abhijith Punnappurath, North York (CA); Mohamed Ashraf Hassan Mohamed Abdelsalam, Toronto (CA); Ran Zhang, Toronto (CA); Michael Brown, Toronto (CA)

(73) Assignee: SAMSUNG ELECTRONICS CO., LTD., Suwon-si (KR)

(21) Appl. No.: 19/545,625

(22) Filed: Feb. 20, 2026

Related U.S. Application Data
(60) Provisional application No. 63/777,494, filed on Mar. 25, 2025.

(51) Int. Cl. H04N 23/88; G06T 7/90

(52) U.S. Cl. CPC H04N 23/88; G06T 7/90; G06T 2207/10024; G06T 2207/20081; G06T 2207/20084

(57) ABSTRACT

A method for improving auto white balance (AWB) includes obtaining a raw image; obtaining metadata associated with the raw image; generating a time-capture feature based on the metadata; generating a histogram feature based on the raw image; obtaining illuminant chromaticity based on a neural network by using the histogram feature and the time-capture feature as inputs; obtaining an RGB illuminant color by converting the illuminant chromaticity; and adjusting one or more white balance parameters of an Image Signal Processor (ISP) based on the RGB illuminant color.

### CROSS-REFERENCE TO RELATED APPLICATION

This application claims the benefit of U.S. provisional application No. 63/777,494 filed on Mar. 25, 2025, the entire contents of which are incorporated herein by reference.

### BACKGROUND

### 1. Field

This disclosure is directed to time-aware auto white balance in mobile photography.

### 2. Related Art

Cameras rely on auto white balance (AWB) to correct undesirable color casts caused by scene illumination and the camera's spectral sensitivity. AWB is typically achieved by using an illuminant estimator, which derives the global color cast based solely on the raw image colors from the camera.

Color constancy refers to the ability of the human visual system to maintain stable object colors despite variations in lighting conditions by leveraging contextual cues within the scene. Cameras approximate this effect using auto white balance (AWB) correction, which aims to partially neutralize color casts introduced by scene illumination and the camera's spectral sensitivity. AWB first estimates the illumination color as an RGB vector in the camera's raw color space. The raw image is then corrected by scaling its color channels according to the estimated illumination, typically under the assumption of a single global light source.

Conventional illuminant estimation methods primarily rely on image colors, either by directly processing the raw image or by analyzing color histograms. These methods can be broadly categorized into two groups: (1) classical statistical-based methods, which estimate the illuminant color based on image statistics, and (2) learning-based methods, which map image colors to their corresponding scene illuminant through data-driven models.

Digital cameras attempt to mimic this perceptual stability through auto white balance (AWB), which aims to correct color casts caused by varying lighting conditions and the camera's spectral response. AWB typically involves two steps: (1) estimating the scene's illuminant as an RGB vector in the raw color space, and (2) applying a diagonal transformation to the image by rescaling the RGB channels to neutralize the color bias. Most traditional and deep learning-based illuminant estimation methods rely solely on the image content-either directly analyzing the raw image or leveraging its color distributions.

However, these models do not take into account the time of day that an image is taken.

### SUMMARY

According to an aspect of the disclosure, a method performed by an electronic device for providing auto white balance (AWB) includes obtaining a raw image; obtaining metadata associated with the raw image; generating a time-capture feature based on the metadata; generating a histogram feature based on the raw image; obtaining illuminant chromaticity based on a neural network by using the histogram feature and the time-capture feature as inputs; and obtaining an RGB illuminant color by converting the illuminant chromaticity; and adjusting one or more white balance parameters of an Image Signal Processor (ISP) based on the RGB illuminant color.

According to an aspect of the disclosure, an electronic device for providing auto white balance (AWB) includes memory, comprising one or more storage media, storing one or more instructions; at least one processor operatively coupled to the memory, in which the one or more instructions, when executed by the at least one processor individually or collectively, cause the electronic device to: obtain a raw image; obtain metadata associated with the raw image; generate a time-capture feature based on the metadata; generate a histogram feature based on the raw image; obtain illuminant chromaticity based on a neural network by using the histogram feature and the time-capture feature as inputs; obtain an RGB illuminant color by converting the illuminant chromaticity; and adjust one or more white balance parameters of an Image Signal Processor (ISP) based on the RGB illuminant color.

According to an aspect of the disclosure, a non-transitory computer readable medium having instructions stored therein, which when executed by a processor, cause the processor to execute a method including obtaining a raw image; obtaining metadata associated with the raw image; generating a time-capture feature based on the metadata; generating a histogram feature based on the raw image; obtaining illuminant chromaticity based on a neural network by using the histogram feature and the time-capture feature as inputs; obtaining an RGB illuminant color by converting the illuminant chromaticity; and adjusting one or more white balance parameters of an Image Signal Processor (ISP) based on the RGB illuminant color.

### BRIEF DESCRIPTION OF DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, in accordance with embodiments of the present disclosure.

FIG. 2 is a block diagram of example components of one or more devices of FIG. 1, in accordance with embodiments of the present disclosure.

FIG. 3 illustrates an example system for performing time-aware auto white balancing, in accordance with embodiments of the present disclosure.

FIG. 4 is a block diagram for performing time-aware auto white balancing, in accordance with embodiments of the present disclosure.

FIG. 5 is a flowchart of an example process for performing time-aware auto white balancing, in accordance with embodiments of the present disclosure.

FIG. 6 is a block diagram for performing time-aware auto white balancing, in accordance with embodiments of the present disclosure.

FIG. 7 is a flowchart of an example process for performing time-aware auto white balancing, in accordance with embodiments of the present disclosure.

FIG. 8 is a block diagram for performing time-aware auto white balancing, in accordance with embodiments of the present disclosure.

FIG. 9 is a flowchart of an example process for performing time-aware auto white balancing, in accordance with embodiments of the present disclosure.

FIG. 10 illustrates an example user interface (UI), in accordance with embodiments of the present disclosure.

FIG. 11 illustrates an example UI in accordance with embodiments of the present disclosure.

FIG. 12 illustrates an example system that uses a pre-existing illuminant estimation module in accordance with embodiments of the present disclosure.

FIG. 13 illustrates an example system that uses a bank of pre-existing illuminant estimation modules in accordance with embodiments with the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware or firmware. The actual specialized control hardware used to implement these systems and/or methods is not limiting of the implementations.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

The embodiments are directed to a lightweight illuminant estimation method that incorporates such contextual metadata, along with additional capture information and image colors, into a lightweight model (e.g., ~5K parameters). Electronic devices (including at least one camera) provide valuable additional metadata—such as capture timestamp and geolocation—that offer strong contextual clues to help narrow down the possible illumination solutions.

While image colors are a key cue for estimating the scene's illuminant, Electronic devices (e.g., mobile devices) provide an opportunity to integrate additional contextual information. For instance, the electronic device's location, along with the date and time, can offer valuable cues about outdoor lighting conditions (e.g., sunrise, noon, sunset), thereby improving illuminant estimation for outdoor scenes.

Intuitively, knowing the time of day when an outdoor scene is captured can help estimate the lighting conditions. The time of day, derived from contextual metadata (e.g., timestamp and geolocation) readily available on electronic devices, provides valuable insights into the likely range of illuminant correlated color temperature (CCT) in outdoor scenes, thereby narrowing the range of possible illuminant colors. For instance, images taken at noon exhibit a different CCT range than those captured at sunrise or sunset. When combined with additional capture information to distinguish between environments (e.g., indoors vs. outdoors), such metadata may complement image colors to improve illuminant estimation accuracy.

According to one or more embodiments, contextual metadata from electronic device is used, along with additional capture information available in camera ISPs, to train a lightweight illuminant estimator model (e.g. ~5K parameters). This compact and efficient design is especially advantageous for edge devices such as mobile devices, where minimizing power consumption and memory usage is critical. The proposed AWB method utilizes contextual metadata (e.g., timestamp and geolocation) alongside capture information to enhance illuminant estimation. Integrating this additional data with conventional color information into a lightweight neural model leads to significant improvements in accuracy.

While image colors provide essential cues for inferring illumination, this approach has limitations-especially in scenes with ambiguous or misleading color information. However, electronic devices offer an opportunity to go beyond image content by incorporating contextual metadata. For example, timestamp and geolocation data can provide powerful priors for outdoor lighting conditions. Knowing the local time and position enables estimation of natural lighting phases such as sunrise, midday, or sunset, which are strongly correlated with specific illuminant colors.

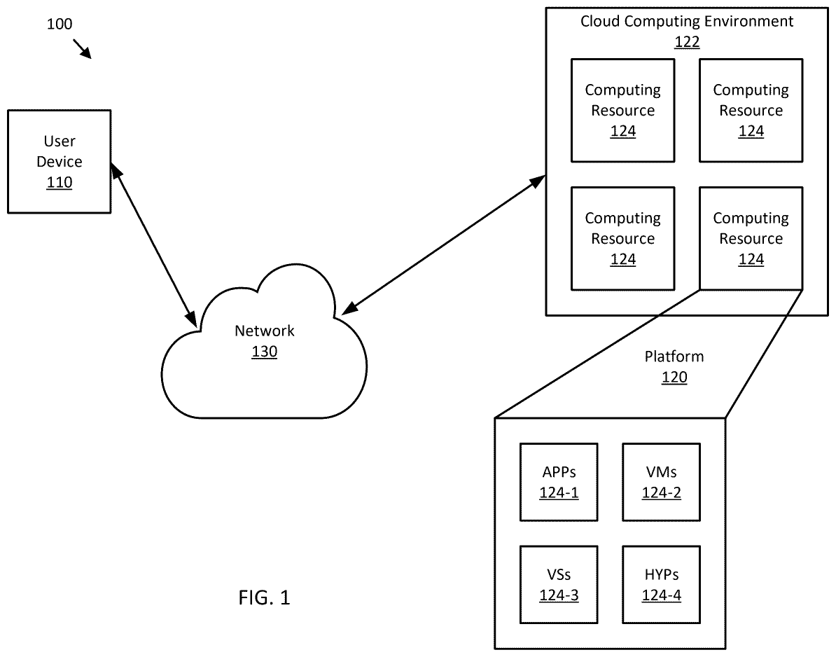

FIG. 1 is a diagram of an environment 100 in which methods, apparatuses, and systems described herein may be implemented, according to embodiments.

As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSs) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

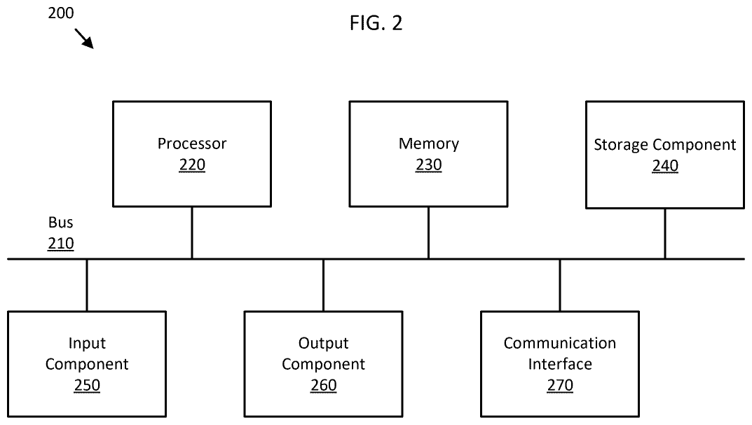

FIG. 2 is a block diagram of example components of one or more devices of FIG. 1. The device 200 may correspond to the user device 110 and/or the platform 120. The device 200 may be any other suitable device such as a TV, wall panel, etc. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

When the device 200 is implemented as a user device 110, the device 200 may be an electronic device comprising one or more cameras. While the electronic device providing AWB is described herein as a user device 110 for illustrative purposes, the present disclosure is not limited thereto.

White balance is a critical component of an Image Signal Processors (ISPs) in camera-equipped electronic devices, typically involving two main stages: (1) estimating the scene's illuminant (e.g., light source illuminating a scene), and (2) correcting the image to remove the resulting color cast. The correction step may involve applying a diagonal matrix that scales the RGB channels to produce a more neutral appearance.

Among these two stages, illuminant estimation is more technically challenging. Illuminant estimation may require analyzing a raw image captured by a specific camera to infer the color of the light source, which introduces a global bias in the recorded colors. Once the illuminant is estimated, the correction step may be performed.

A white balance module may in real time on edge devices (e.g., mobile devices) with limited computational resources, processing each frame during video recording or live preview. Therefore, effective solutions must be both fast and accurate. Related methods that rely solely on image color information often yield suboptimal results, particularly in scenes where color cues are misleading or lack sufficient context. Moreover, learning-based AWB models tend to be camera-specific, requiring retraining or fine-tuning for each new device. This dependency necessitates collecting new training data per sensor-a time-consuming and resource-intensive process for manufacturers, especially in multi-camera systems where different sensors may exhibit varying color responses.

Therefore, the challenges include (1) enabling accurate AWB using an AI-based solution that runs efficiently on edge devices operating at high frame rates; (2) improving estimation accuracy by incorporating contextual metadata (e.g., time and location), rather than relying solely on image color; and (3) achieving scalability by developing a method that generalizes across different camera sensors with minimal calibration effort.

The embodiments of the present disclosure are directed to a lightweight, context-aware illuminant estimation method for auto white balance (AWB) in mobile photography that efficiently incorporates time and geolocation metadata, available in mobile camera ISPs and Digital Negative (DNG) files captured by smartphone cameras. While traditional AWB methods rely solely on image colors, and often struggle under challenging lighting conditions, the embodiments of the present disclosure overcome these challenges.

The embodiments of the present disclosure introduce a time-aware model that leverages contextual metadata (e.g., timestamp and geolocation) to infer a probable scene illumination based on the time of day. This metadata may be combined with capture metadata of camera ISP (e.g., ISO, shutter speed, flash status, and noise statistics) and a histogram-based representation of image colors. The core architecture includes, for example, a compact neural network (e.g., ~5K parameters) that supports real-time deployment on mobile DSPs and CPUs.

Embodiments of the present disclosure include a fusion of contextual metadata with color-based features, which significantly improves AWB accuracy and consistency. The embodiments further include a camera calibration strategy that enables cross-camera deployment by mapping capture metadata (ISP metadata) and color statistics between devices—offering an advantageous solution to a longstanding challenge in AWB generalization.

The embodiments of the present disclosure employ a learnable model that may process two inputs: (1) a time-capture feature, which combines the contextual and capture information available on mobile devices and accessible by their camera ISPs, and (2) a histogram feature, which represents R/G and B/G chromaticity values of the image and an edge image.

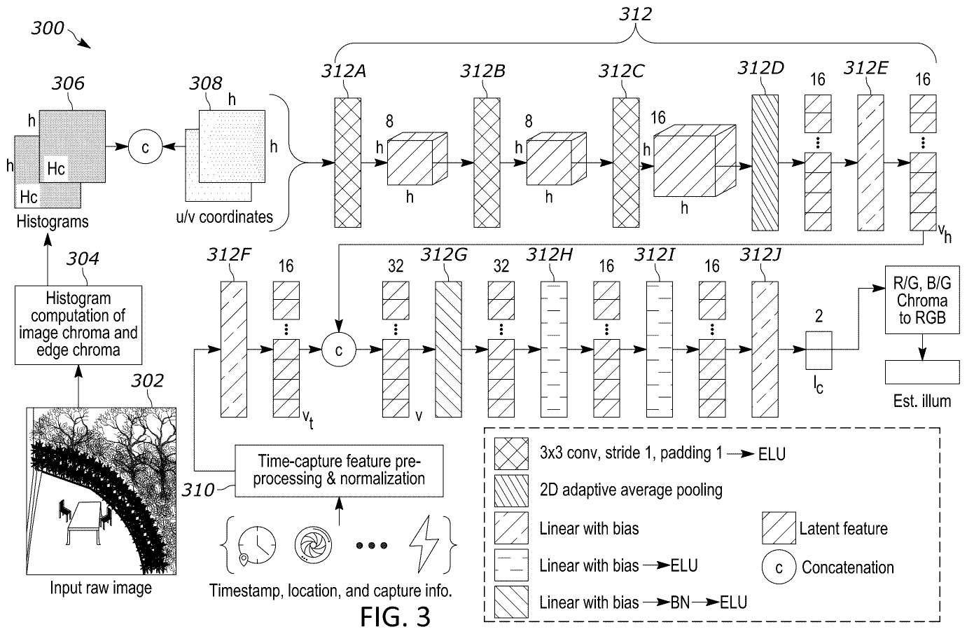

FIG. 3 is an example system 300, according to one or more embodiments. In one or more examples, based on an input of an input raw image 302, a histogram computation 304 is performed on the input raw image 302 to generate histograms 306, which represents R/G and B/G chromaticity values of the image and the edge image. Details regarding the calculation of the histograms 306 will be provided later. The neural network include a first sub-network 312 a second sub-network 314, and a third sub-network 316. The term ‘neural network’ may be used interchangeably with ‘model’. A time capture feature pre-processing and normalization 310 is performed and the time capture feature is processed by the second sub-network 314 to project it into the latent space, producing the time-capture latent feature vector, vₜ∈ [symbol] ¹⁶ The third sub-network 316 processes the histogram feature to produce the histogram's latent feature vector, vₕ∈ [symbol] ¹⁶. Both the histogram and time-capture latent feature vectors may be concatenated and processed by the first sub-network 312 to output an R/G, B/G chromaticity vector, l_{c}∈ [symbol] ², representing the scene illuminant. This 2D vector may then converted into the illuminant RGB color.

In one or more examples, the neural network may be a lightweight model that includes a convolutional network (i.e., the third sub-network 316) that processes the histogram feature (e.g., histograms of image and edge image 306 concatenated with the u/v coordinates 308) to produce a latent feature vₕ, which is then concatenated with the latent feature of the processed by linear layer (i.e., the second sub-network 314) time-capture feature vₜ. The combined feature v may be subsequently passed through a multilayer perceptron (MLP) (i.e., the first sub-network 312) to produce the chromaticity of the scene illuminant, which is finally converted into normalized RGB illuminant color.

In one or more examples, the neural network may include the third sub-network 316 comprising one or more convolution layers (e.g., 3×3 convolution layer), Exponential Linear Unit (ELU) activation layer, 2D adaptive average pooling layer, and linear layer connected in series. The output of last convolution layer may be provided to a 2D adaptive average pooling layer, the output of which is provided to a linear layer. The time capture feature may be provided to the second sub-network 314 comprising one or more linear layers, the output of which is concatenated with the output of the third sub-network 316. This concatenation may be provided to the first sub-network 312. The first sub-network 312 may comprise a plurality of linear layers of different types connected in series. For example, the first sub-network 312 may include a linear layer with Batch Normalization (BN) followed by ELU, a linear layer with an ELU activation layer, and a linear layer, but is not limited thereto.

In one or more examples, the time-capture feature may be first processed to project this feature into a latent space, producing the time-capture latent feature vector, vₜ∈ [symbol] ¹⁶. The model may process the histogram feature to produce the histogram's latent feature vector, vₕ∈ [symbol] ¹⁶. Both the histogram and time-capture latent feature vectors may be concatenated and processed by a set of learnable layers to output an R/G, B/G chromaticity vector, l_{c}∈ [symbol] ², representing the scene illuminant. This 2D vector may be then converted into the illuminant RGB color.

In one or more examples, the model of the present disclosure incorporates contextual metadata, available on electronic devices, as an input feature. For example, a geolocation and a timestamp of an image capture to compute the “probability” of the time of day (e.g., sunset, noon, etc.). In one or more examples, a conventional clock time (hour::minutes) may be converted its corresponding time of day condition based on the date and geolocation of the scene. This approach allows the model to generalize across different time zones and prevents the model from being influenced by the capturing location. As understood by one of ordinary skill in the art, the embodiments are not limited to electronic devices with at least one camera. For example, the model may be downloaded to a standalone camera.

In one or more examples, the time probability vector represents the likelihood that the captured image corresponds to one of the solar event times (e.g., dawn, sunrise, noon, dusk, sunset, or midnight) and may computed as follows:

$${p}_{g} = 1 - \frac{\vert {t}_{c} - {t}_{g} \vert}{{t}_{s}} , \qquad Eq . ( 1 )$$

where t_{c} is the capture time in seconds (adjusted to the local time zone based on geolocation information), and t_{g} is the local time in seconds of the solar event, g E {dawn, sunrise, noon, dusk, sunset, midnight}, computed using geolocation-based standard algorithms. The scalar tₛ may represent the total number of seconds in a day (i.e., 86,400).

According to one or more embodiments, the probability of each solar event, p_{g}, may be pre-processed in a time probability vector by computing the square root to enhance feature representation (e.g., compressing high probabilities and amplifying lower ones), which is intended to help create a more balanced and uniform distribution for the model to leverage. This time probability vector may then be augmented with a one-hot vector, b, that indicates whether the capture time t_{c} of a raw image occurs before or after each solar event. This distinction helps the model account for expected variations in CCT, as illuminant colors can differ before and after certain solar events, such as sunset and sunrise. The value of this one-hot vector for a given solar event g may be computed as:

$${b}_{g} = \{ \begin{matrix}1 , & {t}_{c} \leq {t}_{g} \\ 0 , & otherwise\end{matrix} , \qquad Eq . ( 2 )$$

where b_{g} corresponds to the entry in the one-hot vector for the solar event, g. Both the time probability vector and the one-hot vector together form a time feature, p∈ [symbol] ¹².

According to one or more embodiments, to enrich the feature set with additional capture information available from the camera ISP and that can help distinguish the capturing environment (e.g., indoor vs. outdoor), one or more of following features may be included in the final time-capture feature, c: ISO (i), shutter speed(s), flash statue (f), and noise information.

In one or more examples, the ISO (i) may be the sensitivity of a camera's image sensor to light, where lower values indicate good lighting conditions (e.g., bright scenes) and higher values suggest low-light environments, such as poorly lit indoor scenes.

In one or more examples, the shutter speed(s) may be an amount of time the camera's shutter remains open, allowing light to hit the image sensor. This parameter provides an indication of lighting conditions, alongside the ISO value, i.

In one or more examples, the flash status (f) may be a binary value indicating whether a flash light was used during capturing.

In one or more examples, since image denoising may be applied before or in parallel with illuminant estimation in camera ISPs, explicit noise information from the captured scene may be used. More noise typically indicates low-light conditions, which can provide clues about the lighting color range of the scene. While noise information is accessible within camera ISPs, obtaining accurate noise information for public use may challenging, as noise profiles in DNG files are not always reliable. To address these challenges, the noise information may be simulated using two approaches: noise statistics (stats) and/or signal-to-noise ratio (SNR) stats.

In one or more examples, the noise stats (n) may represent the noise statistics in the captured raw image. The noise stats (n) may be simulated by denoising each raw image and computing the noise stats as the mean and standard deviation of each color channel of the absolute difference between the denoised and noisy raw images. This approach provides an improved method for estimating noise stats, as the denoised images are typically available within the camera ISPs, but difficult to extract from the DNG files.

In one or more examples, SNR stats (r) measures the noise information in the captured image without the need of a clean reference. The SNR may be computed by applying a sliding window (e.g., 15×15) over the raw image and calculating the SNR as:

$$10 {log}_{10} ( \frac{μ}{σ + ϵ} ) ,$$

where μ represents the mean RGB of the patch (e.g., 15×15), σ is the standard deviation, and ϵ is a small value added for numerical stability.

In one or more examples, the complete time-capture feature may be the combination of these inputs and may be expressed as follows:

$$c = {[ {p}^{T} , log ( i ) , log ( s ) , f , {w}^{T} ]}^{T} , \qquad Eq . ( 3 )$$

where w represents optional noise-related features, which can include either noise stats n, SNR stats r, or both. Alternatively, w may be omitted if noise information is not considered.

In one or more examples, the time-capture feature may be first normalized using min-max normalization (with the min and max values computed from the training data), and then processed through a learnable function, fₜ, as follows:

$${v}_{t} = {f}_{t} ( c ) , \qquad Eq . ( 4 )$$

where fₜ denotes the second sub-network (e.g. a learnable linear layer) that transforms the time-capture feature, c, into its latent representation, vₜ∈ [symbol] ¹⁶ (see FIG. 3).

According to one or more embodiments, in addition to the time-capture feature, c, the neural model may be provided with a histogram feature, H, which represents the colors of the raw image. In one or more examples, a 2D histogram may be used to represent the R/G and B/G chromaticities of the input raw image, I∈ [symbol] ^{n×3}, where n denotes the total number of pixels in the raw image. For example, the 2D chromaticity histogram, H_{c}∈ [symbol] ^{h×h}, may be as follows:

$${H}_{c}^{( m , n )} = {\sum }_{k} {‖ {I}^{( k )} ‖}_{2} \cdot {δ}_{m , n}^{( k )} , \qquad Eq . ( 5 )$$

$${δ}_{m , n}^{( k )} = [ {u}_{m} \leq {rg}^{( k )} < {u}_{m + 1} ] ∧ [ {v}_{n} \leq {bg}^{( k )} < {v}_{n + 1} ] , \qquad Eq . ( 6 )$$

where rg^{(k)} and bg^{(k)} are the R/G and B/G chromaticity values of pixel k in I, and ∥l^{(k)}∥₂ represents the intensity of pixel k (i.e., Euclidean norm of the pixel's RGB values). The notation Λ denotes the logical AND operator, and [⋅] is the Iverson bracket, which evaluates to 1 when the condition is true and 0 otherwise. The histogram bins may be defined by the edges {uₘ} and {vₙ}, where uₘ and vₙ are the lower edges of the bins, and uₘ₊₁ and vₙ₊₁ are the corresponding upper edges.

In one or more examples, the histogram accumulates the brightness values of pixels whose chromaticity values fall within the range [uₘ, uₘ₊₁) along the R/G axis (i.e., the u-axis) and [vₙ, vₙ₊₁) along the B/G axis (i.e., the v-axis). Following the work in the convolutional color constancy (CCC), the square root of the histogram is computed to enhance the utility of the histogram feature.

In one or more examples, this histogram differs from the log-uv histogram, which operates in the logarithmic space of G/R and G/B. The R/G, B/G chromaticity histogram performs better, as it aligns with both the histogram representation and the model's output space.

In one or more examples, in addition to the chromaticity histogram, H_{c} of the image colors, the histogram feature may be augmented with the square-rooted chromaticity histogram of the image's edges, Hₑ, where the image edges are computed as follows:

$${E}^{( x , y )} = \frac{1}{8} {\sum }_{Δ x , Δ y} \vert {I}^{′ ( x , y )} - {I}^{′ ( x + Δ x , y + Δ y )} \vert , \qquad Eq . ( 7 )$$

where E represents the image edges, I′ refers to the raw image in 3D tensor form (height, width, channels), and Δx,Δy∈{—1,0,1} with (Δx,Δy)≠(0,0). The edge histogram, Hₑ, is computed from E using Eqs. (5) and (6)

In one or more examples, the histogram feature is constructed by concatenating the two histograms, H_{c} and Hₑ. Since this histogram feature is first processed by convolutional (conv) layers, as shown in FIG. 3, additional channels that encode the positional information of the u/v coordinates in histogram space are appended, which helps capture spatial relationships within the histogram feature. In one or more examples, the final histogram feature, in the form of a 3D tensor form, H∈ [symbol] ^{h×h×4}, comprises 2 channels representing the chromaticity of the image and its edges, along with the additional u/v coordinate channels.

In one or more examples, the histogram feature may be processed through a series of convolution layers with ELU activation. The resulting latent representation undergoes adaptive average pooling before passing through a linear layer to produce the histogram's latent feature vector, vₕ∈ [symbol] ¹⁶, as follows:

$${v}_{h} = {f}_{h} ( H ) , \qquad Eq . ( 8 )$$

where fₙ denotes the third sub-network (e.g., conv layers, ELU activation, pooling, and linear layers) that maps the histogram feature into its latent space, as shown in FIG. 3.

In one or more examples, both feature vectors, vₜ and vₕ, may be concatenated to produce the latent vector v, and processed by an illuminant estimation sub-network as follows:

$$v = [ {v}_{t} ; {v}_{h} ] , \qquad Eq . ( 9 )$$

$${l}_{c} = {f}_{l} ( v ) , \qquad Eq . ( 10 )$$

where fₗ denotes the first sub-network comprises a set of linear layers, with batch normalization applied to the first layer, followed by activation functions—except for the final layer, which outputs l_{c}, the chromaticity vector of the scene illuminant. This vector is then transformed into an unnormalized RGB illuminant color by mapping [R/G,B/G]^{T}→[R/G,1,B/G]^{T}, followed by normalization via division by its L2 norm to produce the final illuminant color. The parameters fₜ, fₕ, and fₗ may be optimized to minimize an angular error between the predicted RGB illuminant color and the ground-truth RGB illuminant color.

In one or more examples, while contextual metadata is largely device-independent (e.g., expected to vary minimally across devices), the embodiments include capture-specific information—such as ISO, shutter speed, noise, and SNR statistics—as well as image colors, making it inherently camera-dependent. This dependency prevents the trained neural network in FIG. 3 from generalizing to new cameras without fine-tuning or retraining, similar to most learning-based illuminant estimation models.

To address this limitation, a lightweight calibration operation may be performed for any new camera. For example, images of a color chart may be captured under various correlated color temperature (CCT) lighting conditions (e.g., 2850K, 3500K, 5500K, 7000K) using both the original (training) camera and the new (inference) camera. From these captures, a single matrix (e.g., 3×3) that maps the chart colors from the training camera to the inference camera may be computed, and another matrix for the inverse mapping. Furthermore, in one or more examples, a polynomial projection function to transform camera-specific metadata (ISO, shutter speed, noise, SNR) from the inference camera may be fit to the training camera domain.

At inference time, the calibrated matrix (e.g., 3×3) may be applied to map the image colors into the training camera's color space and compute the corresponding histogram as described earlier. Similarly, the inference camera's metadata may be projected into the training camera domain, which ensures that all inputs—both image-based and metadata—are in the same domain as the model was trained on. The model then predicts the illuminant color in the training camera's color space, which is subsequently mapped back to the inference camera's space using the inverse matrix (e.g., 3×3).

According to one or more embodiments, to train and validate the model, a dataset that includes contextual information (e.g., timestamp and geolocation) for each image may be used. In one or more examples, the dataset is generated using linear raw images covering a wide range of scenes both indoors and outdoors, at various times of day (e.g., sunset, sunrise, noon, night). The dataset may include images captured under various light sources (e.g., sunlight, incandescent, LED), as well as non-standard illuminant colors (e.g., colored LED light). In one or more examples, the dataset may capture scenes under different weather conditions (sunny, cloudy, rain, snow, etc.).

In one or more examples, ground-truth illuminant colors are collected for each scene. For example, for each scene, an image with a calibration color chart, which is used to extract the illuminant color from the gray patches, may be first captured. Next, an image of the same scene without the color chart may be captured. After obtaining the ground-truth illuminant color, all color chart images may be discarded. This approach allows natural images that mimic real-world scenarios to be tested without the need to mask out the color chart patch.

Since the dataset includes a wide variety of lighting conditions, such as sunset/sunrise, night scenes, and artificial light, a “user-preference” ground truth, in addition to the neutral ground truth obtained from the color chart for each scene in the dataset, may be generated. These features account for human incomplete chromatic adaptation in such scenes and user preference. For example, an expert photographer may be asked to assign a ground truth illuminant to each scene in order to make it appear more natural, reflect real-world observations, and enhance the aesthetics of the image. In one or more examples, the same person who captured the scene may also performed the annotation, ensuring that the user-preference selection was based on real-world observations of how the scene should appear.

In one or more examples, a mask for regions illuminated by non-dominant illuminants in each scene may be created. These masks may ensure that all scenes have only one dominant illuminant, matching the color of the neutral ground truth, without confounding effects from other illuminants.

The embodiments of the present disclosure leverage the probability of the time of day, allowing the model to rely on an absolute time reference rather than being affected by location-specific time zones, thereby improving generalization. Solar event times (e.g., dawn, sunrise, noon, dusk, sunset, and midnight) vary significantly based on the time of year and geographical location. For instance, locations near the equator experience minimal variation in day length, whereas higher-latitude regions exhibit more pronounced seasonal differences. The average length of daylight across different countries and continents. As understood by one of ordinary skill in the art, sunset/sunrise times vary depending on both location and date. If the raw clock timestamp without geolocation were used, the information would be highly location-dependent and would not generalize well to regions with different solar event timings. An alternative approach would be to provide both geolocation and timestamp, allowing the model to learn their relationship with solar event timings. However, this would require a diverse dataset with images captured across different locations worldwide to ensure robust learning, which may be impractical due to the extensive data collection required. The embodiments of the present disclosure is easier to implement and more effective—instead of relying on learned patterns. The embodiments of the present disclosure use traditional astronomical methods to compute solar event times for a given location, which allows time to be represented in an absolute manner, using the probability of an image being captured at each solar event rather than relying on location-specific timestamps.

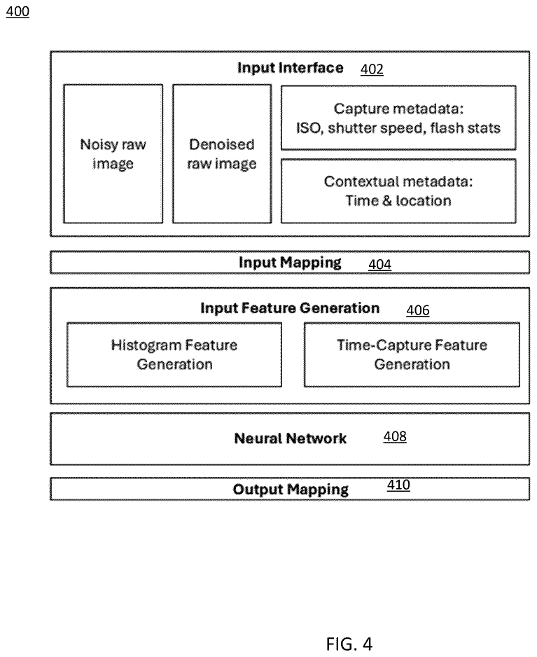

FIG. 4 illustrates an example architecture 400 for performing time-aware AWB, according to one or more embodiments.

The architecture 400 includes an input interface 402 that may accept various inputs available from mobile camera ISPs or stored within DNG files. The input interface 402 may obtain a noisy raw image and a corresponding denoised version. The denoised version is generally not available in DNG files, and therefore, a denoiser may be applied to obtain the denoised image in use cases where a denoised raw input is not directly supported, such as in image editing software, using noise information. The input interface 402 may obtain capture information including capture metadata (e.g., ISO, flash status, shutter speed). The input interface 402 may obtain contextual metadata such as local time and geolocation information (latitude and longitude). The input interface 402 may obtain noise information.

In one or more examples, the input mapping 404 may be used when the inference camera differs from the one used during model training. In such cases, pre-calibrated mapping functions (e.g., applying calibrated matrix) may be applied to transform the input data (e.g., the noisy raw image's colors, noise statistics, SNR statistics, shutter speed, and ISO) from the inference camera's space into the training camera's space.

In one or more examples, the input feature generation 406 may process the input data to generate the input features to the neural network component. The input feature generation 406 may include histogram feature generation and time-capture feature generation. The histogram feature generation component may generate the histogram feature from the input raw image (optionally resized), and may perform the following processes: (i) generate the edge image as described in Eq. (7); (ii) generate 2D histogram for both the image chroma and the edge image chroma, following Eqs. (5) and (6); (iii) construct the final histogram feature H∈ [symbol] ^{h×h×4} by concatenating the square-rooted 2D histograms with the positional encoding of the u/v coordinates in the histogram space.

The time-capture feature component may generate the time-capture feature. The time-capture feature component may perform the following processes: (i) obtain contextual metadata and capture metadata (ii) generate the noise stats (n) by computing the mean and standard deviation of each color channel of the absolute difference between the denoised and noisy raw images; (iii) generate the SNR stats (r) by applying a sliding window (e.g., 15×15) over the raw image and calculating the SNR as:

$$10 {log}_{10} ( \frac{μ}{σ + ϵ} ) ,$$

where μ represents the mean RGB of the patch (e.g., 15×15), σ is the standard deviation, and ϵ is a small value added for numerical stability; (iv) generate the time feature as described in Eqs. (1) and (2); and (v) generate the time-capture feature as described in Eq. (3).

The neural network 408 may be a trained neural network that processes the input features and predicts the final illuminant color in chromaticity space. The predicted chromaticity may then be converted into an RGB illuminant color for white balance correction.

The output mapping 410 may be used only the inference camera differs from the one used during model training. In such cases, pre-calibrated mapping functions (e.g. applying inverse of the calibrated matrix) may be applied to transform the predicted illuminant from the training camera space back to the inference camera space.

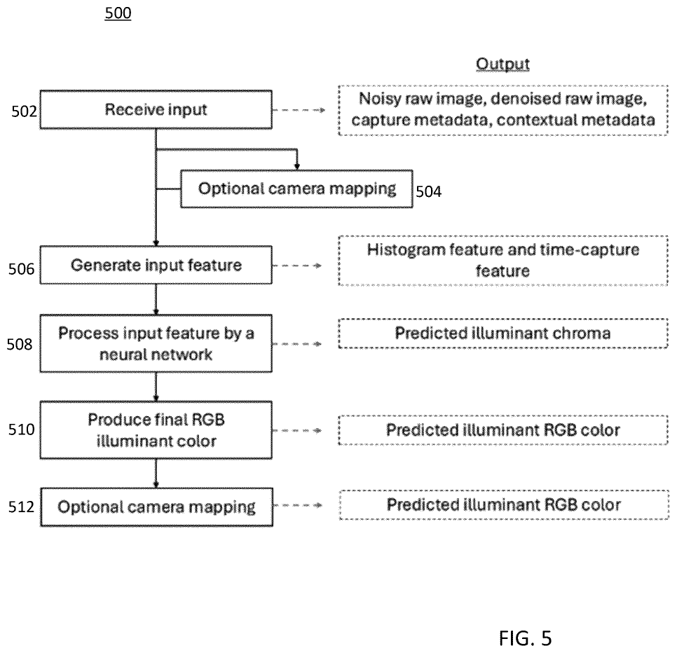

FIG. 5 illustrates a flowchart of an example process 500 for perform time-aware AWB, according to one or more embodiments. The process 500 may include the following operations.

Operation 502. Receive input: Obtain a noisy raw image and its denoised version, capture metadata (ISP, shutter speed, flash status), and contextual metadata (time and location).

Operation 504. Camera mapping: Input mapping from the inference camera space to the training camera space. This operation may be optional. For example, operation 504 may be performed when the inference camera differs from the camera used during model training.

Operation 506. Generate input feature: Generate input feature (histogram feature and time-capture feature).

Operation 508. Process input feature: Process input feature by learnable weights of a neural network to predict the final illuminant color in chromaticity space.

Operation 510. Produce final RGB illuminant color: Convert predicted chromaticity illuminant to RGB illuminant color.

Operation 512. Camera Mapping: Output mapping from the training camera space to the inference camera space. This operation may be optional. For example, operation 512 may be performed in response to operation 504 being performed.

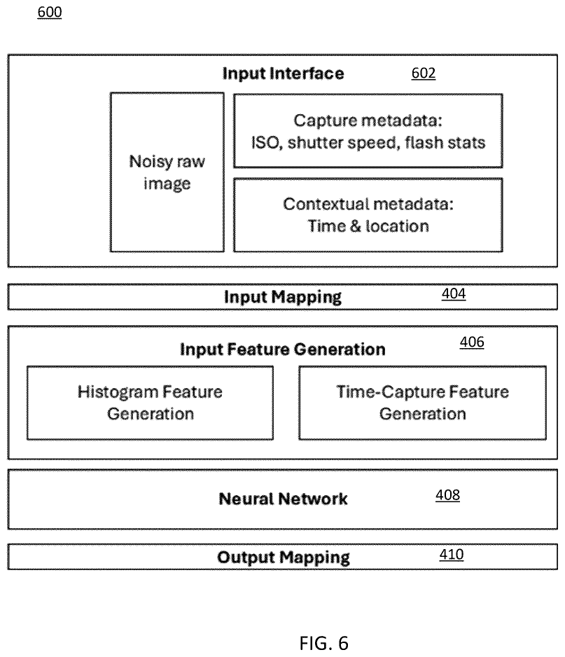

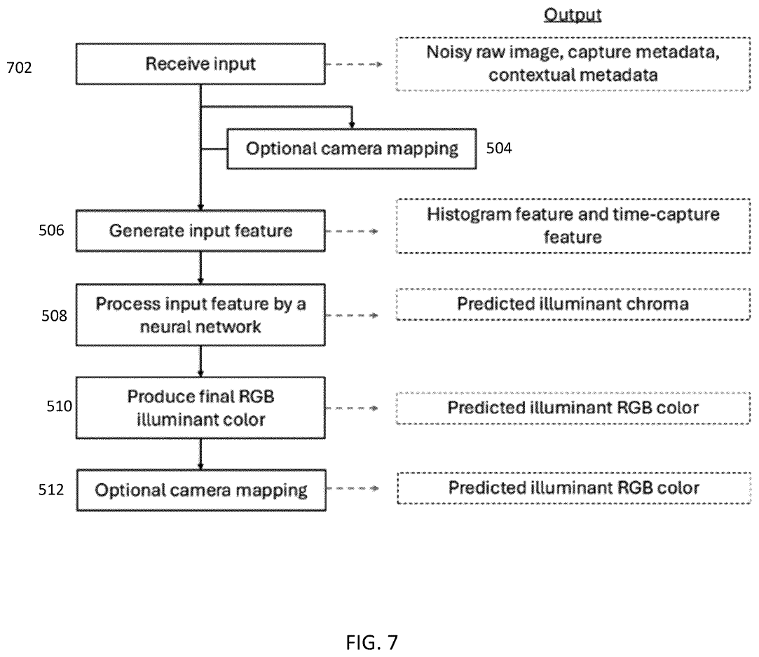

FIG. 6 illustrates an example architecture 600 for performing time-aware AWB, according to one or more embodiments. The architecture 600 includes an input interface 602. Compared to the input interface 402 of the architecture 400, the input interface 602 does not obtain a denoised raw image. The remaining components of the architecture 600 corresponding to the architecture 400. FIG. 7 illustrates a flowchart of an example process 700 for perform time-aware AWB, according to one or more embodiments. The process 700 includes an operation 702 for receiving an input. Compared to operation 502 in FIG. 5, the operation 702 does not obtain a denoised image. The remaining operations in FIG. 7 correspond to the operations in FIG. 5.

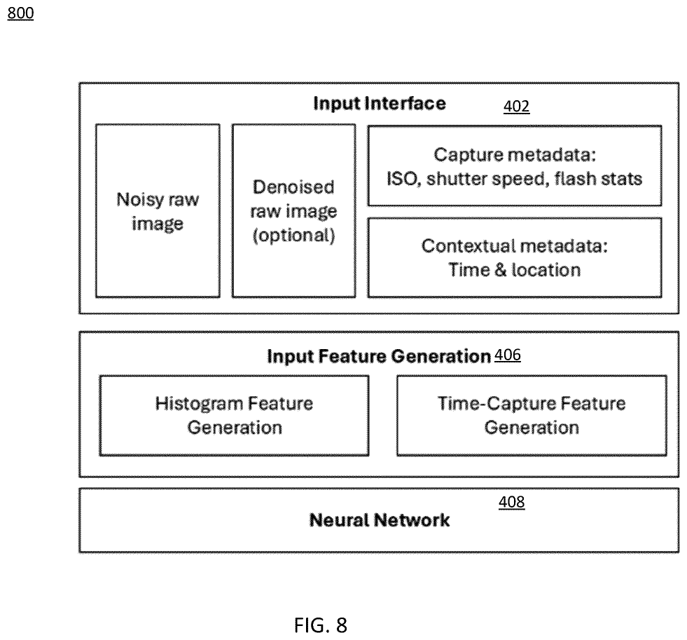

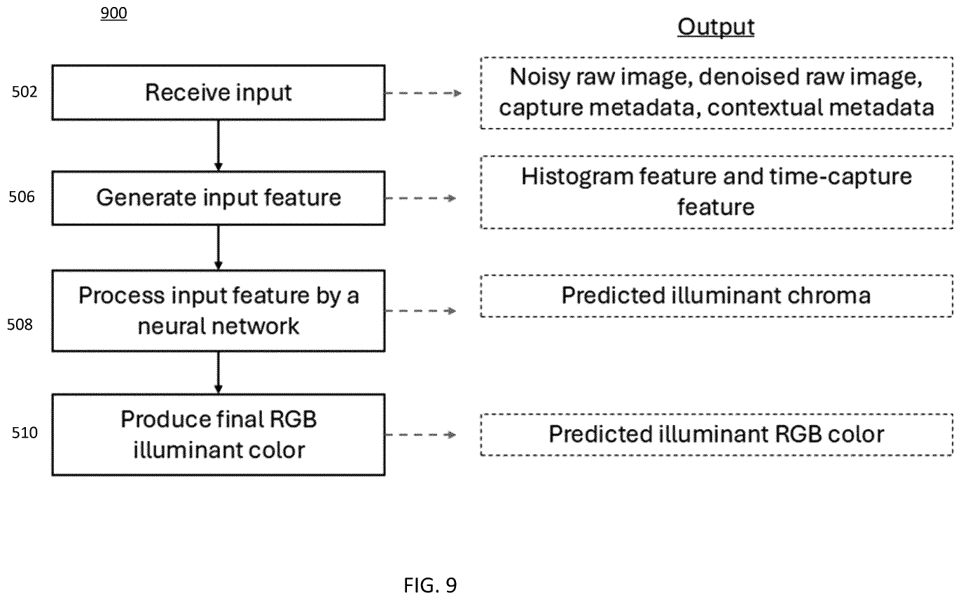

FIG. 8 illustrates an example architecture 800 for performing time-aware AWB, according to one or more embodiments. Compared to the architecture 400, the architecture 800 does not include the input mapping 404 and the output mapping 410 and obtaining a denoised raw image is optional. FIG. 9 illustrates a flowchart of an example process 900 for performing time-aware AWB, according to one or more embodiments. Compared to the process 500, the process 900 does not include the camera mapping operations 504 and 512 and obtaining the denoised raw image of the operation 502 is optional.

The embodiments of the present disclosure may be applied to Mobile HDR and Low-Light Photography. Edge devices (e.g., mobile phones) often capture multi-frame HDR or low-light bursts, where AWB instability across frames leads to temporal color flickering. Our method addresses this by incorporating time-of-day and scene context, resulting in stable and consistent white balance across frames—improving both visual quality and HDR fusion performance.

The embodiments of the present disclosure may be applied to outdoor scene photography: Illuminant colors in outdoor environments vary significantly based on the time of day (e.g., sunrise vs. noon vs. sunset). The model in the embodiments of the present disclosure uses timestamp and geolocation to infer the likely illuminant range, significantly improving accuracy in outdoor photography, especially in complex lighting scenarios like golden hour, twilight, or mixed shadows.

The embodiments of the present disclosure may be applied to on-device real-time AWB in Camera ISPs. With only compact parameters (e.g., ~5K) and sub-millisecond runtime on mobile DSPs, the method is ideal for integration into electronic device ISPs—enabling real-time inference without increasing battery drain or latency, and enhancing user-perceived quality without requiring server-side processing. In one or more examples, the embodiments of the present disclosure may be an app that is downloaded from an app store. For example, referring to FIG. 1, the user device 110 may be a smartphone that accesses an app store to download an application that implements the system 300 (FIG. 3) on the user device 110. In one or more examples, the embodiments of the present disclosure may be a native application installed on the user device 110.

The embodiments of the present disclosure may be applied to image editing and post-processing tools. Software like image editing software, image post-processing software, may use the model of the embodiments of the disclosure for automatic white balance correction of raw photos by using available EXIF metadata (time, location, ISO, etc.), improving color accuracy for photographers with minimal manual adjustment.

According to one or more embodiments, the model in the embodiments of the present disclosure may be trained using an optimization algorithm (e.g., an Adam optimizer) for a predetermined number of epochs (e.g., 400 epochs) with specific hyperparameters (e.g., betas set to (0.9, 0.999)) and a weight decay factor (e.g., 10⁻⁹). A warm-up strategy may be applied to gradually increase the learning rate from a first value (e.g., 10⁻⁶) to a second value (e.g., 10⁻³) over a specific initial period (e.g., the first 5 epochs). Subsequently, a learning rate schedule (e.g., a cosine annealing schedule) may be used. A batch-size adjustment strategy may be employed during training, starting with a batch size of (e.g., 8) and increasing it at regular intervals (e.g., doubling it every 100 epochs). Images of a specific resolution (e.g., 384×256 pixels) may be used in all experiments, which is a reasonable size for camera pipelines with limited computational power. In one or more examples, histograms with a predetermined number of bins (e.g., 48 bins) may be used. The histogram boundaries may be determined by computing specific statistical measures of the chromaticity values (e.g., the 10th and 95th percentiles) along each chromaticity axis from the training set.

The embodiments of the present disclosure may be evaluated using a dataset that includes contextual information (e.g., timestamp and geolocation) for each image. A predetermined number of raw images (e.g., 3,224 linear raw images) may be captured with the electronic device (e.g., mobile phone's main camera), covering a wide range of scenes (e.g., both indoors and outdoors), at various times of day (e.g., sunset, sunrise, noon, night). The dataset may include images captured under various light sources (e.g., sunlight, incandescent, LED), as well as non-standard illuminant colors (e.g., colored LED light).

For each scene, an image with a calibration color chart, which is used to extract the illuminant color from the gray patches, may be captured. Next, an image of the same scene without the color chart may be captured. Since the dataset includes a wide variety of lighting conditions, such as sunset/sunrise, night scenes, and artificial light, a “user-preference” ground truth may be generated in addition to the neutral ground truth obtained from the color chart for each scene in the dataset. This is to account for human incomplete chromatic adaptation in such scenes and user preference. In one or more examples, a ground truth illuminant may be assigned to each scene in order to make it appear more natural, reflect real-world observations, and enhance the aesthetics of the image. Out of the exemplary dataset comprising a total number of images (e.g., 3,224 raw images), may be organized into a training set consisting of a first number of images (e.g., 2,619 raw images), a validation set consisting of a second number of images (e.g., 205 raw images), and a testing set consisting of a third number of images (e.g., 400 raw images).

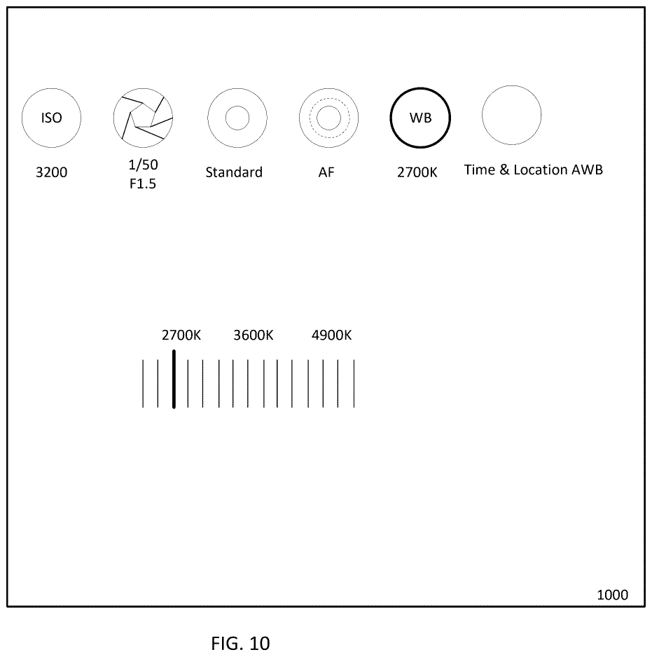

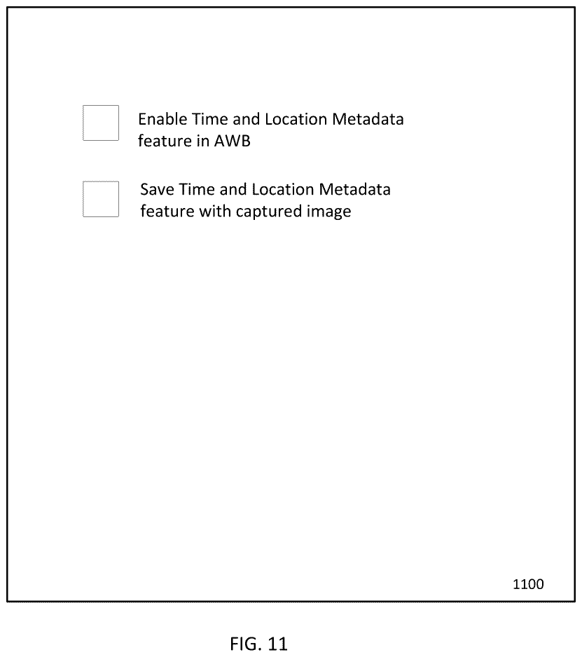

FIG. 10 illustrates an example user interface (UI) 1000 that may be displayed to a user via the user's smartphone or camera. The UI 1000 may provide one or more operations related to a camera on the smartphone such as ISO, aperture, autofocus, WB, etc. In one or more examples, the UI 1000 includes a “Time & Location AWB” button. Upon selection of this button, UI 1100 illustrated in FIG. 11 may be displayed to the user. The UI 1100 may provide the user an option to enable time and location metadata to be used in AWB, as illustrated in FIG. 3. Furthermore, the UI 1100 may provide the user an option to enable time and location metadata to be saved with the captured image. For example, when an image is captured and stored in memory, the time and location metadata may be saved with the captured image so that this metadata may be used when AWB is performed on the image at a later time.

The embodiment illustrated in FIG. 3 discloses an illumination estimation model architecture that takes both the color histograms and the proposed time-capture feature as its inputs. This model may be trained from scratch.

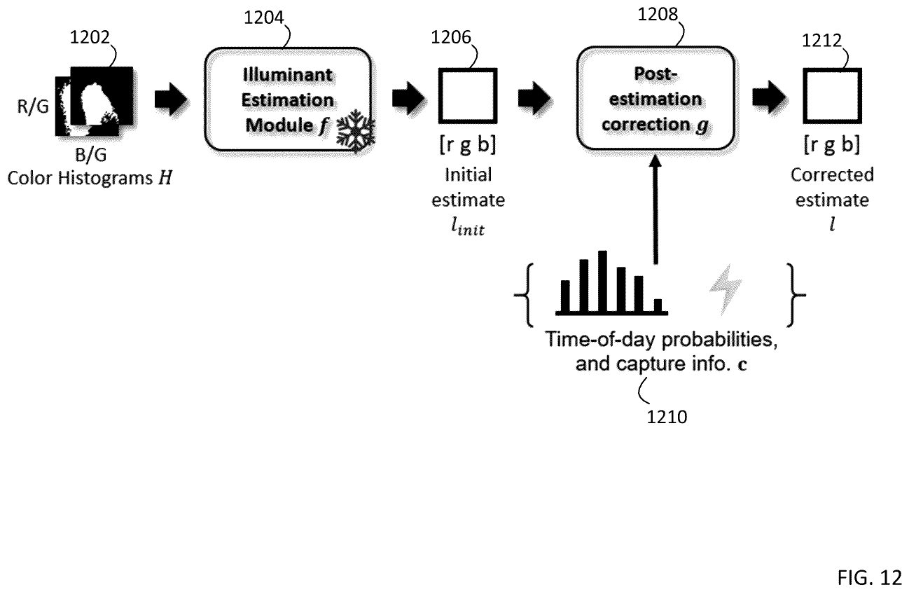

FIG. 12 illustrates an alternative system 1200 that may use a pre-existing illuminant estimation module 1204, for example, one that is already onboard the camera image signal processor (ISP). For example, as illustrated in FIG. 12, color histograms H 1202 may be provided to the illuminant estimation module 1204, which outputs an initial estimate 1260 (l_init). Subsequently, a post-estimation correction g module 1208 receives the initial estimate 1206 and time capture features 1210, and provides a corrected estimate (l) 1212.

Existing illuminant estimation modules typically take in color histograms of the input raw image and output an estimated illuminant lᵢₙᵢₜ=f(H). Other forms of inputs may be used as well. Because such modules cannot leverage the time-of-day as prior information, the initial estimate lᵢₙᵢₜ may be inaccurate. A post-illumination-estimation neural network g may be used to predict a corrected illuminant based on the time-capture feature c and the initial estimate lᵢₙᵢₜ. This process may be summarized as: l=g(f(H),c)

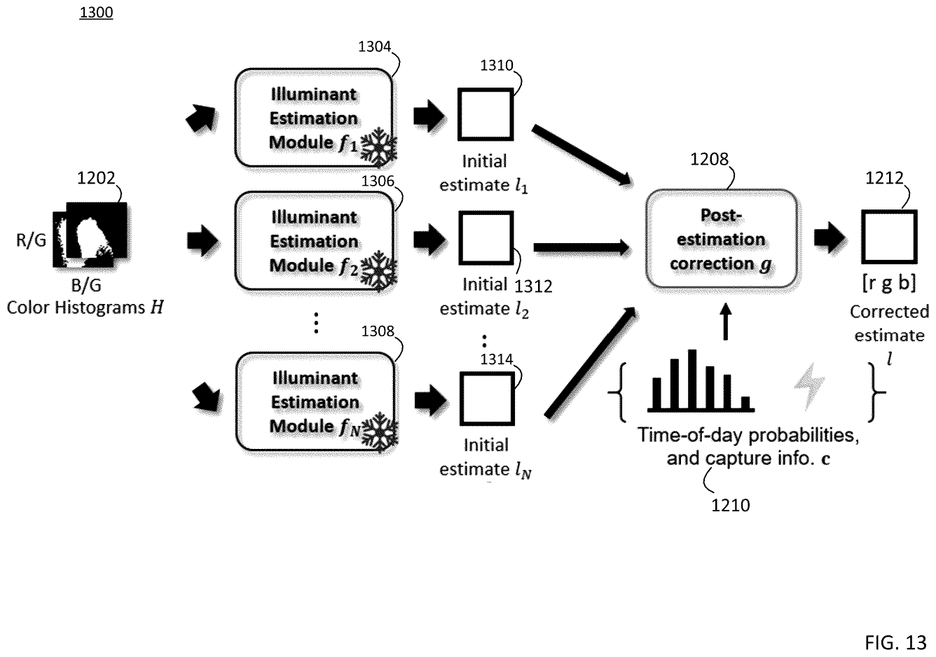

FIG. 13 illustrates another alternative system 1300 for the correction module g 1208 to take in an ensemble of pre-estimated illuminants. In one or more examples, the color histograms H 1202 are provided to a bank of illumination estimation modules f₁(1304), f₂ (1306), . . . , f_{N} (1308), each outputting a slightly different illuminant l₁ (1310), l₂ (1312), . . . , l_{N} (1314), where a weighted average may be used as the final prediction. Instead of using uniform weights, the time-capture feature c 1210 may be used to guide the blending of the initial estimates (1310-1314) by the post-estimation correction g module 1208. The post-estimation correction g module 1208 takes in the pre-estimated illuminants and the time-capture feature 1210, and may either explicitly predict blending coefficients or directly output the final result l 1212. In one or more examples, time-of-day probabilities and capture metadata may provide prior information on which illuminants should be weighted more during averaging. This process may be summarized as: l=g([l₁, . . . , l_{N}],c).

The embodiments of the present disclosure provide significantly advantageous features including: (1) enabling accurate AWB using an AI-based solution that runs efficiently on mobile devices by incorporating contextual and capture metadata within a lightweight model (e.g., ~5K parameters) capable of real-time inference at high frame rates on mobile DSPs and CPUs; (2) improving estimation accuracy by leveraging contextual metadata (e.g., time of day and geolocation) in addition to image colors, allowing the model to better infer likely scene illumination in varied lighting conditions; (3) Achieving scalability across different camera sensors through a simple calibration-based mapping of metadata and color features, enabling cross-camera deployment without the need for re-training. Together, these features offer a novel, practical, and highly efficient solution to persistent AWB challenges in mobile imaging.

The above disclosure also encompasses the embodiments listed below:

According to an aspect of the disclosure, A method performed by an electronic device for providing auto white balance (AWB), the method comprising: obtaining a raw image and metadata associated with the raw image; generating a time-capture feature based on the metadata; generating a histogram feature based on the raw image; obtaining illuminant chromaticity based on a neural network by using the histogram feature and the time-capture feature as inputs; obtaining an RGB illuminant color by converting the illuminant chromaticity; and adjusting one or more white balance parameters of an Image Signal Processor (ISP) based on the RGB illuminant color.

The metadata comprises a timestamp and geolocation corresponding to a capture of the raw image.

The time-capture feature and the histogram feature are concatenated to form a latent vector.

The latent vector is processed through a first sub-network of the neural network that outputs the illuminant chromaticity.

The time-capture feature comprises solar event information that indicates one of a plurality of solar events and a binary indicator that indicates whether the time the raw image was captured is before or after the one of the plurality of solar events.

The plurality of solar events comprise dawn, sunrise, noon, dusk, sunset, and midnight.

The generating of the time-capture feature comprises generating the time-capture feature further based on the capture information available from the ISP.

The capture information comprises at least one of a sensitivity to light (ISO), a shutter speed, and a flash status.

The capture information comprises noise information including at least one of noise statistics and SNR statistics.

The generating of time-capture feature comprises generating the time-capture feature further based on noise information of the capture information.

The generating of the time-capture feature comprises normalizing the time-capture feature using min-max normalization based on predetermined minimum and maximum values.

The normalized time-capture feature is processed through a second sub-network of the neural network that transforms the normalized time-capture feature into a latent representation.

The histogram feature comprises a 2D chromaticity histogram that represents R/G and B/G chromaticities of the raw image, and a 2D edge chromaticity histogram that represents R/G and B/G chromaticities of edges of the raw image.

The generating of the histogram feature comprises forming a final histogram feature in the form of a 3D tensor form by concatenating the 2D chromaticity histogram and 2D edge chromaticity histogram, and appending u/v coordinate channels.

The final histogram feature is processed through a third sub-network of the neural network that transforms the final histogram feature into a latent representation.

Based on determining that a first camera associated with the neural network is different from a second camera of a device that captured the raw image: performing input mapping by applying a calibrated matrix to map the raw image colors into the first camera's color space and projecting the second camera's capture metadata into the first camera domain; and performing output mapping by applying an inverse of the calibrated matrix to map back the RGB illuminant color into the second camera's color space.

According to an aspect of the disclosure, An electronic device for providing auto white balance (AWB), the electronic device comprising: memory, comprising one or more storage media, storing one or more instructions; and at least one processor operatively coupled to the memory.

The one or more instructions, when executed by the at least one processor individually or collectively, cause the electronic device to: obtain a raw image and metadata associated with the raw image, generate a time-capture feature based on the metadata, generate a histogram feature based on the raw image, obtain illuminant chromaticity based on a neural network by using the histogram feature and the time-capture feature as inputs, obtain an RGB illuminant color by converting the illuminant chromaticity, and adjust one or more white balance parameters of an Image Signal Processor (ISP) based on the RGB illuminant color.

Wherein the metadata comprises a timestamp and geolocation corresponding to a capture of the raw image.

The time-capture feature and the histogram feature are concatenated to form a latent vector.

The latent vector is processed through a first sub-network of the neural network that outputs the illuminant chromaticity.

The time-capture feature comprises solar event information that indicates one of a plurality of solar events and a binary indicator that indicates whether the time the raw image was captured is before or after the one of the plurality of solar events.

The plurality of solar events comprise dawn, sunrise, noon, dusk, sunset, and midnight.

The one or more instructions, when executed by the at least one processor individually or collectively, cause the electronic device to generate the time-capture feature further based on the capture information available from the ISP.

The capture information comprises at least one of a sensitivity to light (ISO), a shutter speed, and a flash status.

The one or more instructions, when executed by the at least one processor individually or collectively, cause the electronic device to normalize the time-capture feature using min-max normalization based on predetermined minimum and maximum values.

The normalized time-capture feature is processed through a second sub-network of the neural network that transforms the normalized time-capture feature into a latent representation.

The histogram feature comprises a 2D chromaticity histogram that represents R/G and B/G chromaticities of the raw image, and a 2D edge chromaticity histogram that represents R/G and B/G chromaticities of edges of the raw image.

The one or more instructions, when executed by the at least one processor individually or collectively, cause the electronic device to form a final histogram feature in the form of a 3D tensor form by concatenating the 2D chromaticity histogram and 2D edge chromaticity histogram, and appending u/v coordinate channels.

The final histogram feature is processed through a third sub-network of the neural network that transforms the final histogram feature into a latent representation.

The one or more instructions, when executed by the at least one processor individually or collectively, cause the electronic device to, based on determining that a first camera associated with the neural network is different from a second camera of a device that captured the raw image: perform input mapping by applying a calibrated matrix to map the raw image colors into the first camera's color space and projecting the second camera's capture metadata into the first camera domain, and perform output mapping by applying an inverse of the calibrated matrix to map back the RGB illuminant color into the second camera's color space.

According to an aspect of the disclosure, a non-transitory computer readable medium having instructions stored therein, which when executed by a processor, cause the processor to execute a method comprising: obtaining a raw image and metadata associated with the raw image; generating a time-capture feature based on the metadata; generating a histogram feature based on the raw image; obtaining illuminant chromaticity based on a neural network by using the histogram feature and the time-capture feature as inputs; obtaining an RGB illuminant color by converting the illuminant chromaticity; and adjusting one or more white balance parameters of an Image Signal Processor (ISP) based on the RGB illuminant color.

What is claimed is:

1. A method performed by an electronic device for providing auto white balance (AWB), the method comprising:
obtaining a raw image and metadata associated with the raw image;
generating a time-capture feature based on the metadata;
generating a histogram feature based on the raw image;
obtaining illuminant chromaticity based on a neural network by using the histogram feature and the time-capture feature as inputs;
obtaining an RGB illuminant color by converting the illuminant chromaticity; and
adjusting one or more white balance parameters of an Image Signal Processor (ISP) based on the RGB illuminant color.

2. The method of claim 1, wherein the metadata comprises a timestamp and geolocation corresponding to a capture of the raw image.

3. The method of claim 1,
wherein the time-capture feature and the histogram feature are concatenated to form a latent vector, and
wherein the latent vector is processed through a first sub-network of the neural network that outputs the illuminant chromaticity.

4. The method of claim 3,
wherein the time-capture feature comprises solar event information that indicates one of a plurality of solar events and a binary indicator that indicates whether the time the raw image was captured is before or after the one of the plurality of solar events, and
wherein the plurality of solar events comprise dawn, sunrise, noon, dusk, sunset, and midnight.

5. The method of claim 4,
wherein the generating of the time-capture feature comprises generating the time-capture feature further based on the capture information available from the ISP,
wherein the capture information comprises at least one of a sensitivity to light (ISO), a shutter speed, and a flash status.

6. The method of claim 5,
wherein the capture information further comprises noise information including at least one of noise statistics and SNR statistics,
wherein the generating of time-capture feature comprises generating the time-capture feature further based on noise information of the capture information.

7. The method of claim 5,
wherein the generating of the time-capture feature comprises normalizing the time-capture feature using min-max normalization based on predetermined minimum and maximum values, and
wherein the normalized time-capture feature is processed through a second sub-network of the neural network that transforms the normalized time-capture feature into a latent representation.

8. The method of claim 3
wherein the histogram feature comprises a 2D chromaticity histogram that represents R/G and B/G chromaticities of the raw image, and a 2D edge chromaticity histogram that represents R/G and B/G chromaticities of edges of the raw image.

9. The method of claim 8,
wherein the generating of the histogram feature comprises forming a final histogram feature in the form of a 3D tensor form by concatenating the 2D chromaticity histogram and 2D edge chromaticity histogram, and appending u/v coordinate channels, and
wherein the final histogram feature is processed through a third sub-network of the neural network that transforms the final histogram feature into a latent representation.

10. The method of claim 1, further comprising:
based on determining that a first camera associated with the neural network is different from a second camera of a device that captured the raw image:
performing input mapping by applying a calibrated matrix to map the raw image colors into the first camera's color space and projecting the capture metadata of the second camera into the first camera domain; and
performing output mapping by applying an inverse of the calibrated matrix to map back the RGB illuminant color into the second camera's color space.

11. An electronic device for providing auto white balance (AWB), the electronic device comprising:
memory, comprising one or more storage media, storing one or more instructions; and
at least one processor operatively coupled to the memory,
wherein the one or more instructions, when executed by the at least one processor individually or collectively, cause the electronic device to:
obtain a raw image and metadata associated with the raw image,
generate a time-capture feature based on the metadata,
generate a histogram feature based on the raw image,
obtain illuminant chromaticity based on a neural network by using the histogram feature and the time-capture feature as inputs,
obtain an RGB illuminant color by converting the illuminant chromaticity, and
adjust one or more white balance parameters of an Image Signal Processor (ISP) based on the RGB illuminant color.

12. The electronic device of claim 11, wherein the metadata comprises a timestamp and geolocation corresponding to a capture of the raw image.

13. The electronic device of claim 11,
wherein the time-capture feature and the histogram feature are concatenated to form a latent vector, and
wherein the latent vector is processed through a first sub-network of the neural network that outputs the illuminant chromaticity.

14. The electronic device of claim 13,
wherein the time-capture feature comprises solar event information that indicates one of a plurality of solar events and a binary indicator that indicates whether the time the raw image was captured is before or after the one of the plurality of solar events, and
wherein the plurality of solar events comprise dawn, sunrise, noon, dusk, sunset, and midnight.

15. The electronic device of claim 14, wherein the one or more instructions, when executed by the at least one processor individually or collectively, cause the electronic device to generate the time-capture feature further based on the capture information available from the ISP,
wherein the capture information comprises at least one of a sensitivity to light (ISO), a shutter speed, and a flash status.

16. The electronic device of claim 15, wherein the one or more instructions, when executed by the at least one processor individually or collectively, cause the electronic device to normalize the time-capture feature using min-max normalization based on predetermined minimum and maximum values, and
wherein the normalized time-capture feature is processed through a second sub-network of the neural network that transforms the normalized time-capture feature into a latent representation.

17. The electronic device of claim 13, wherein the histogram feature comprises a 2D chromaticity histogram that represents R/G and B/G chromaticities of the raw image, and a 2D edge chromaticity histogram that represents R/G and B/G chromaticities of edges of the raw image.

18. The electronic device of claim 17, wherein the one or more instructions, when executed by the at least one processor individually or collectively, cause the electronic device to form a final histogram feature in the form of a 3D tensor form by concatenating the 2D chromaticity histogram and 2D edge chromaticity histogram, and appending u/v coordinate channels, and
wherein the final histogram feature is processed through a third sub-network of the neural network that transforms the final histogram feature into a latent representation.

19. The electronic device of claim 11, wherein the one or more instructions, when executed by the at least one processor individually or collectively, cause the electronic device to:
based on determining that a first camera associated with the neural network is different from a second camera of a device that captured the raw image:
perform input mapping by applying a calibrated matrix to map the raw image colors into the first camera's color space and projecting the capture metadata of the second camera into the first camera domain, and
perform output mapping by applying an inverse of the calibrated matrix to map back the RGB illuminant color into the second camera's color space.

20. A non-transitory computer readable medium having instructions stored therein, which when executed by a processor, cause the processor to execute a method comprising:
obtaining a raw image and metadata associated with the raw image;
generating a time-capture feature based on the metadata;
generating a histogram feature based on the raw image;
obtaining illuminant chromaticity based on a neural network by using the histogram feature and the time-capture feature as inputs;
obtaining an RGB illuminant color by converting the illuminant chromaticity; and
adjusting one or more white balance parameters of an Image Signal Processor (ISP) based on the RGB illuminant color.
